(19) United States
(12) Patent Application Publication
(10) Pub. No.: US 2026/0352124 A1
(43) Pub. Date: Nov. 5, 2026

(54) METHOD FOR MANUFACTURING AT LEAST ONE STATOR FOR AN ELECTROMECHANICAL INERTIAL DRIVE

(71) Applicant: PHYSIK INSTRUMENTE (PI) SE & CO. KG, Karlsruhe (DE)

(72) Inventor: Burhanettin KOC, Ettlingen (DE)

(21) Appl. No.: 19/486,796

(22) PCT Filed: May 14, 2024
(86) PCT No.: PCT/EP2024/063196

§ 371 Date: Nov. 21, 2025

(30) Foreign Application Priority Data
May 31, 2023 (DE) 10 2023 114 237.2

(51) Int. Cl. H02N 2/00; H02N 2/02

(52) U.S. Cl. CPC H02N 2/22; H02N 2/025

(57) ABSTRACT

A method is provided for manufacturing at least one stator for an electromechanical inertia drive, wherein the stator comprises at least one electromechanical actuator and a stator frame for accommodating the actuator. In order to reduce the manufacturing costs for the stator, the stator frame comprises a plurality of components which are produced in a separation process from at least one sheetlike semi-finished product and are arranged in a stacked composite to form the stator frame.

### CROSS REFERENCE TO RELATED APPLICATIONS

This application is a 371 U.S. National Phase of International Application No. PCT/EP2024/063196, filed on May 14, 2024, which claims priority to German Patent Application No. 10 2023 114 237.2, filed on May 31, 2023. The entire disclosures of the above applications are incorporated herein by reference.

### BACKGROUND

### Technical Field

The present invention relates to a method for manufacturing at least one stator for an electromechanical inertial drive.

### Related Art

US 2022/0255467 A1, WO 2021/190953 A1 and WO 2022/135905 A1 disclose known methods. As FIGS. 1a to 1d show, the stator 1 known from the prior art has a stator frame 3 for accommodating two electromechanical actuators 2. As can be seen from FIG. 2, the known stator frame 3 comprises a stator base 5, which accommodates the electromechanical actuators 2 in a cavity 7. The stator base 5 of the known stator 1 is typically a one-piece component that is manufactured using CNC machining. The manufacture of a stator comprising such a CNC-machined stator base 5 is complex and expensive.

Therefore, an object underlying the invention is providing a method with which the manufacturing costs of a stator for an electromechanical inertia drive can be reduced.

### SUMMARY

To solve this problem, the present invention provides a novel method.

The problem is solved in that the stator frame comprises a plurality of components which are manufactured from at least one sheetlike semi-finished product in a thermal or mechanical separation process and are arranged in a stacked composite to form the stator frame. In other words, the stator frame according to the invention is defined by a stacked composite of a plurality of components, all of which are produced from at least one sheetlike semi-finished product in a separation process.

The fact that the stator frame is formed from several individual components in a stacked composite and each of these individual components is produced in a cost-effective separation process from a readily available and consequently inexpensive semi-finished product means that the overall manufacturing costs for the stator can be significantly reduced.

Advantageous further developments are also provided.

It can be advantageous if the stator frame comprises at least two spring sheets and a stator base having at least two components, which is arranged between the two spring sheets. While the stator base is provided to receive the at least one electromechanical actuator, the external spring sheets can be used to provide a connection to a higher-level structure in which the stator is installed.

It can be helpful if an additional flat spring is arranged on one of the spring sheets. The flat spring can be used to apply a suitable preload force to the at least one electromechanical actuator.

It can be practical if the components of the stator frame are manufactured from at least two different plate-shaped semi-finished products with different thicknesses. This allows components to be provided that meet different requirements in terms of rigidity or elasticity. In particular, it can be useful if the components of the stator base are made from a thicker semi-finished product in order to provide sufficient rigidity for supporting the at least one electromechanical actuator. On the other hand, it may be useful if the spring sheets are made of a thinner semi-finished product in order to exhibit a certain elasticity.

It can be advantageous if different components of the stator frame are manufactured from a common plate-shaped semi-finished product. This allows components of the same thickness to be manufactured efficiently and cost-effectively.

It can be advantageous if the stator base has a cavity in which the at least one electromechanical actuator is inserted, and the components of the stator base are preferably manufactured from semi-finished products of the same thickness, particularly preferably from the same semi-finished product. By manufacturing the components of the stator base from the same semi-finished product, i.e. having the same thickness, a rigid stator base can be provided which adequately supports the actuator.

It can be advantageous if the components of the stator base are formed by a support element, on which the at least one electromechanical actuator is placed, and a housing element, which at least partially surrounds the at least one electromechanical actuator, wherein the support element is preferably rod-shaped and the housing element is preferably U-shaped. The support element and/or the housing element can be subdivided into further elements if necessary. Such shapes of the support element and housing element can be cut out of the semi-finished product quickly and easily.

It may prove helpful if the components of the stator frame are aligned with each other via reference means, preferably formed by through holes and/or threaded holes, and the stacked assembly is preferably fixed by connecting means, preferably by screws or welded connections.

It may be practical if the separation process is preferably a laser cutting process, a water jet cutting process or a spark erosion process.

It can prove useful if a plurality of component groups, each formed by a series composite of a plurality of components of the same type, are arranged in a stacked composite to form a plurality of stator frames in a series composite. This allows several stator frames to be produced at the same time, which improves the efficiency of stator production.

It can be useful if the components in a series composite are manufactured integrally connected from a semi-finished product.

It can be useful if the multiple stator frames in the series composite are separated from each other to provide individual stator frames.

### TERMS AND DEFINITIONS

In the context of the present invention, a sheetlike semi-finished product refers to a sheetlike raw material or workpiece or semi-finished product. The sheetlike semi-finished product is formed, for example, plate-shaped, e.g. made of plastic, metal or ceramic, and preferably extends in a plane. Preferably, the sheetlike semi-finished product has the same cross-section in its thickness direction, i.e. perpendicular to its plane of extension.

In the context of the present invention, a stacked composite refers to a stacked arrangement of several components that are fixed to one another using a joining process.

In the context of the present invention, a series composite refers to an arrangement of a plurality of components next to one another, which are preferably integrally, particularly preferably materially, connected to one another by connecting sections.

In the context of the present invention, an electromechanical actuator refers to an element that changes its geometric dimensions due to the application of electrical energy.

### BRIEF DESCRIPTION OF THE DRAWINGS

FIGS. 1a to 1d show a stator 1 according to the prior art in various views.

FIG. 2 shows a stator base 5 of the stator 1 known from the prior art.

FIGS. 3a and 3b show a first embodiment of the stator base 5 of a stator 1 comprising two components 5.1, 5.2, which is manufactured according to the method according to the invention.

FIGS. 4 to 10 show the production of several stator frames 3 or stators 1 in a series composite according to a first embodiment, wherein the respective stack composite of a stator frame 3 is produced by screw connections.

FIGS. 4a and 4b show a partially machined semi-finished product that is used to manufacture the stator base 5 according to FIG. 3, which has two components 5.1, 5.2, in a top view and a perspective view.

FIGS. 5a and 5b show the first embodiment of the two components 5.1, 5.2 of the stator base 5 manufactured from the semi-finished product of FIG. 4 by means of a separation process in a series composite G5.1, G5.2 in a top view and a perspective view.

FIGS. 6a and 6b show a first embodiment of the spring plate halves 4.1 3 manufactured from a semi-finished product by means of a separation process in a series composite G4.1 in a top view and a perspective view.

FIG. 7 shows a series composite G4 of spring sheets 4, which is formed from two series composites G4.1 of spring sheet halves 4.1 of the first embodiment connected by welded connections S.

FIG. 8 shows the series composite G4 of spring sheets 4 from FIG. 7, in which a friction element 9 is applied to each spring sheet 4.

FIG. 9 shows a stacked and pre-assembled arrangement of the series composites G4, G5.1 and G5.2 of the first embodiment.

FIGS. 10a and 10b show in different perspective views a stacked composite of the series composites G4, G5.1, G5.2, G4 and G6, which forms a series composite G3 of a plurality of stator frames 3 or, in conjunction with the electromechanical actuators 2 and the friction elements 9, a series composite G1 of stators 1.

FIGS. 11 to 17 show the production of several stators 1 in a series composite according to a second embodiment, whereby the respective stack composite of a stator frame 3 is produced by welded connections S.

FIG. 11 shows a second embodiment of the spring plate halves 4.1 manufactured from a semi-finished product by means of a separation process in a series composite G4.1.

FIGS. 12a and 12b show a second embodiment of the two components 5.1, 5.2 of the stator base 5 manufactured from a semi-finished product by means of a separation process in a series composite G5.1, G5.2.

FIG. 13 shows a series composite G4 of spring sheets 4, which is formed from two series composites G4.1 of spring sheet halves 4.1 of the second embodiment connected by welded connections S.

FIG. 14 shows the series composite G4 of spring sheets 4 from FIG. 13, in which a friction element 9 is applied to each spring sheet 4.

FIGS. 15a and 15b show a stacked series composite of the series composites G5.1 and G5.2 of the second embodiment in different perspective views, wherein two components 5.1 and 5.2 are fixed to each other by welded connections S to form a series composite G5 of stator bases 5.

FIG. 16 shows a stacked arrangement of individual series composites G4, G5, G4 and G6 according to the second embodiment in an exploded view.

FIGS. 17a and 17b show in different views the welded connections S for producing a series composite G3 of several stator frames 3 or, in conjunction with the electromechanical actuators 2 and the friction elements 9, a series composite G1 of stators 1 from the series composites G4, G5, G4 and G6 shown in FIG. 16.

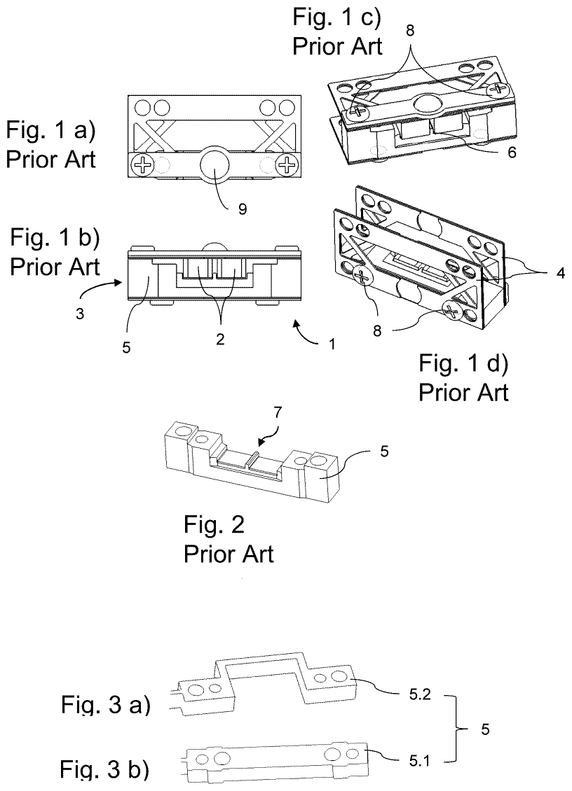

### DETAILED DESCRIPTION

Preferred embodiments of the present invention will be described in detail below with reference to the attached figures.

FIGS. 3a and 3b show the two components 5.1, 5.2 forming a stator base 5 according to a first embodiment. In particular, FIG. 3b shows a support element 5.1 which is provided to support the electromechanical actuators 2, and FIG. 3a shows a housing element 5.2 which is provided to at least partially surround the electromechanical actuators 2. The support element 5.1 is preferably rod-shaped and the housing element 5.2 is preferably U-shaped. When the two components 5.1 and 5.2 are arranged in a stacked composite, a cavity 7 is formed (see FIG. 9) in which the electromechanical actuators 2 can be accommodated. The two components 5.1 and 5.2 of the stator base 5 are provided with through-holes or threaded holes.

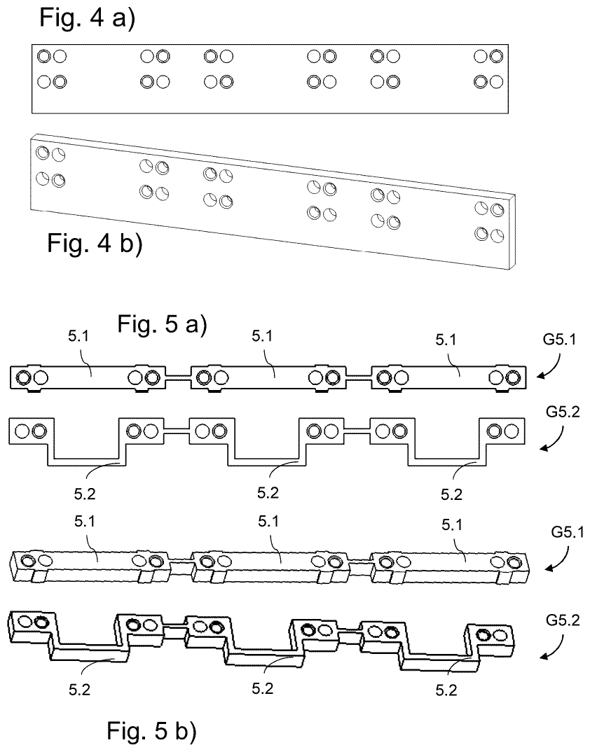

With reference to FIGS. 4 to 10, the manufacture of a plurality of stators 1 in a series composite according to a first embodiment is described below. The first embodiment is substantially characterized in that the respective stacked composite of a stator frame 3 is produced by connecting means, such as screws.

FIGS. 4a and 4b show a sheetlike semi-finished product already provided with through-holes or threaded holes, which is used to manufacture the stator base 5 according to FIG. 3 comprising two components 5.1, 5.2. The semi-finished product is in particular a plate-shaped element of constant thickness, which preferably extends in one plane and is made of metal.

As can be seen from the various views in FIGS. 5a and 5b, a series composite G5.1 of support elements 5.1 and a series composite G5.2 of housing elements 5.2 are manufactured from the aforementioned semi-finished product by means of a separation process. The individual support elements 5.1 are arranged next to each other in the series composite G5.1, whereby two support elements 5.1 are integrally connected via a common connecting section, which is formed, for example, as a material web. The individual housing elements 5.2 in the series composite G5.2 are connected to each other in the same way. Because the series composite G5.1 of support elements 5.1 and the series composite G5.2 of housing elements 5.2 are manufactured from the same semi-finished product, the individual support elements 5.1 and housing elements 5.2 have the same thickness, which is preferred. However, the series composite G5.1 and G5.1 may of course also be made from different semi-finished products, possibly with different thicknesses.

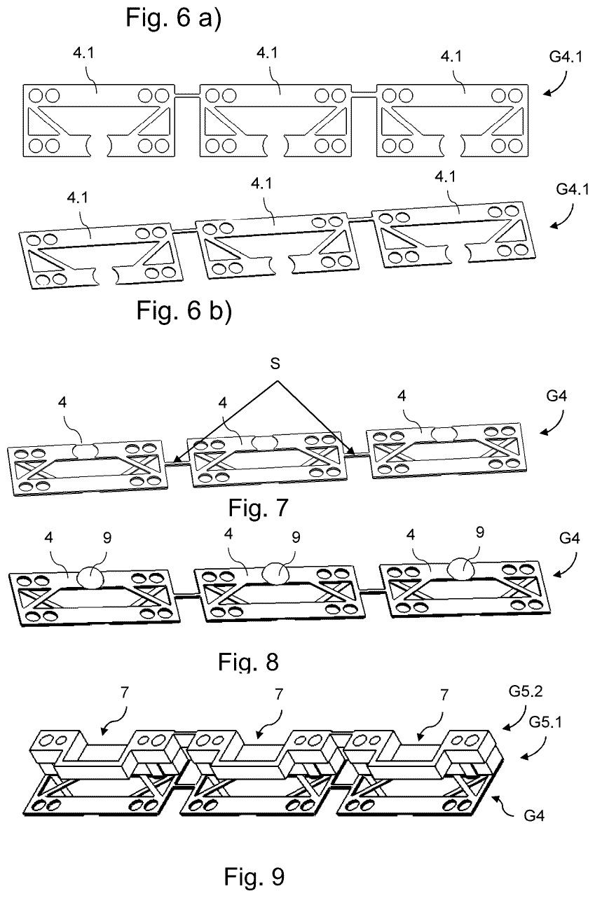

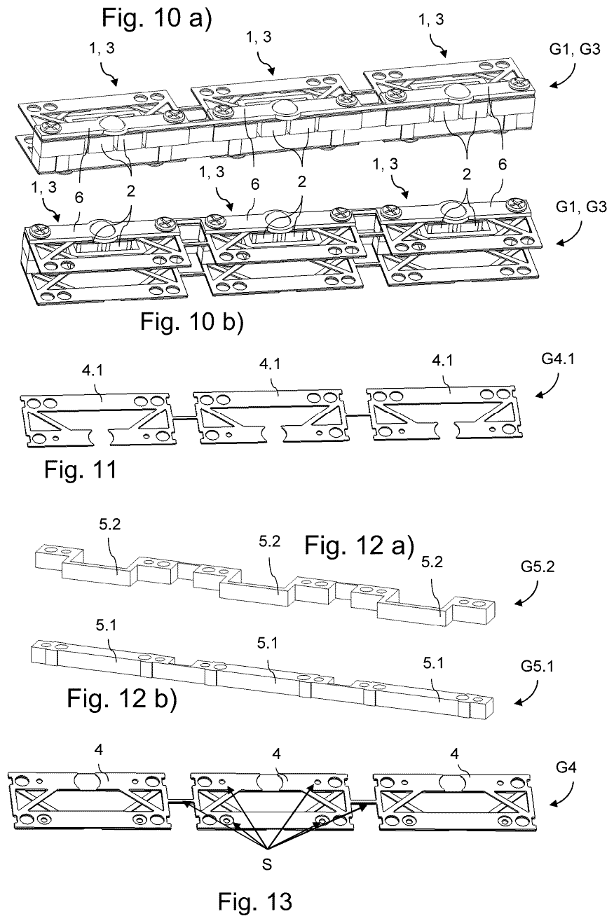

FIGS. 6a and 6b show different views of a series composite G4.1 of spring sheet halves 4.1 according to the first embodiment. The series composite G4.1 of spring sheet halves 4.1 is also manufactured from a sheetlike semi-finished product, preferably a plate-shaped element made of metal or a sheet by means of a separation process. Analogous to the series composites G5.1 and G5.2, the individual spring sheet halves 4.1 are arranged next to each other in the series composite G4.1, whereby two spring sheet halves 4.1 are integrally connected via a common connecting section, which is formed, for example, as a material web. Each spring sheet half 4.1 is also provided with through holes. Preferably, the spring sheet halves 4.1 are made of a thinner semi-finished product than the components 5.1 and 5.2 of the stator base 5. As shown in FIG. 7, to form a series composite G4 of spring sheets 4, two series composites G4.1 of spring sheet halves 4.1 are welded together, whereby the two series composites G4.1 are not stacked congruently to each other, but one series composite G4.1 is rotated by 180° in relation to the other series composite G4.1 around the longitudinal axis. The welded connections S are preferably set at the connecting sections of the series composites G4.1 at which two spring sheet halves 4.1 are connected to each other. FIG. 8 shows the series composite G4 of spring sheets 4 from FIG. 7, in which a friction element 9 is applied to each spring sheet 4. The friction elements 9, which are hemispherical in the present embodiment, can be attached to the spring sheets 4 using epoxy resin, whereby the position of the friction elements can be predetermined by a recess in the corresponding spring sheet half 4.1.

FIG. 9 shows a stacked arrangement of the series composites G4, G5.1 and G5.2. The individual series composites G4, G5.1 and G5.2 can be pre-assembled in a stacked composite using screws that penetrate the through-holes of the spring sheets 4 and the support elements 5.1 and are screwed into the threaded holes of the housing elements 5.2. The screws are not visible in this view, as the screw heads are located on the side of the series composite G4 of the spring sheets 4. The electromechanical actuators 2 are then inserted into the cavity 7 of each stator base 5 and fixed to the respective support element 5.1 using epoxy resin.

As can be seen in FIGS. 10a and 10b, the stacked composite is finally completed using a further series composite G4 of spring sheets 4 and a series composite G6 of flat springs 6 and further screws, so that a series composite G3 of stator frames 3 and a series composite G1 of stators 1 are produced. Since electromechanical actuators 2 are already accommodated in the individual stator frames 3 and a friction element 9 is attached to each stator frame 3, this step not only creates a series composite G3 of stator frames 3, but also a series composite G1 of stators 1. Epoxy resin is also applied to the upper side of the electromechanical actuators 2 in order to create a firm connection to the spring sheet 4 located above. In the stacked composite of a stator frame 3, the stator base 5, which has two components 5.1, 5.2, is therefore arranged between two spring sheets 4. The spring sheets 4 mainly serve to connect the stator 1 to a higher-level structure. A flat spring 6 is preferably arranged on the spring sheet 4 equipped with the friction element 9 and serves to apply a preload force to the electromechanical actuators 2. Analogous to the series composites G4, G5.1 and G5.2, the individual flat springs 6 are arranged next to each other in the series composite G6, with two flat springs 6 being integrally connected via a common connecting section in each case (see FIG. 16). The individual flat springs 6 are also provided with through-holes. Finally, the series composite G1 of the stators 1 is released at the respective connection sections of the individual series composites G4, G5.1, G5.2, G4 and G6 by a separation process, i.e. the individual stators 1 are separated from each other.

FIGS. 11 to 17 show the production of a plurality of stators 1 in a series composite according to a second embodiment, the second embodiment being substantially characterized in that the respective stack composite of a stator frame 3 is produced by welded connections S. Apart from the difference that the stacked composite in the process according to FIGS. 11 to 17 is produced by welded connections S instead of screw connections, the production of the stators 1 is basically identical to the manufacturing process shown in FIGS. 4 to 10. The differences are therefore mainly discussed below.

As can be seen from FIGS. 11 and 12, the individual components 4.1, 5.1 and 5.2 in the series composites G4.1, G5.1 and G5.2 according to the second embodiment may have a slightly different shape than the components known from the first embodiment (cf. FIGS. 5 and 6), but are also manufactured from a sheetlike semi-finished product by means of a separation process. In particular, there is no need for threaded holes in the components for the second embodiment. Instead, the individual components are provided with holes or recesses where the components can be easily welded together.

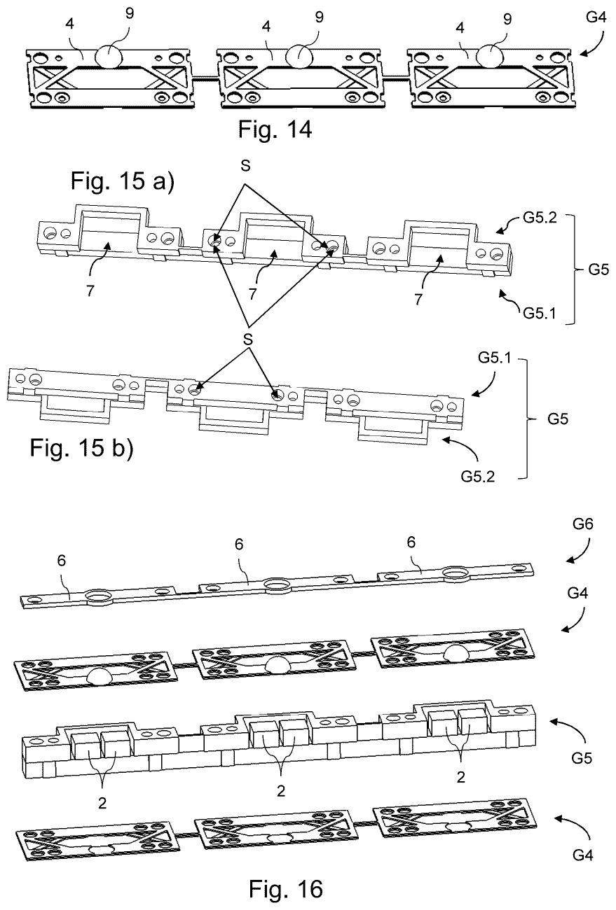

FIG. 13 shows preferred positions of the welded connections S for producing a series composite G4 of spring sheets 4 from two series composites G4.1 of spring sheet halves 4.1 according to the second embodiment. The preferred positions of the welded connections S are only shown on one spring sheet 4 in the series composite G4, but apply analogously to all spring sheets 4 in the series composite G4. Analogous to FIG. 8, FIG. 14 shows the series composite G4 of spring sheets 4, in which a friction element 9 is applied to each spring sheet 4.

FIGS. 15a and 15b show preferred positions of the welded connections S for producing a series composite G5 of stator bases 5 from a series composite G5.1 of support elements 5.1 and a series composite G5.2 of housing elements 5.2 according to the second embodiment. The preferred positions of the welded connections S are only shown on one stator base 5 in the series composite G5, but apply analogously to all stator bases 5 in the series composite G5.

FIG. 16 shows an exploded view of the series composites G4, G5, G4 and G6 in the arrangement in which they are subsequently welded to form a stacked composite. The electromechanical actuators are already inserted into the cavities 7 of the stator bases 5.

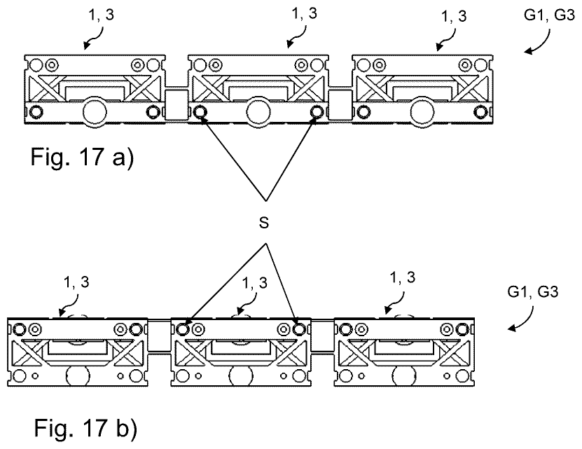

FIGS. 17a and 17b show preferred positions of the welded connections S for producing a series composite G3 of a plurality of stator frames 3 or a series composite G1 of a plurality of stators 1 from the series composites G4, G5, G4 and G6 shown in FIG. 16.

In the above description, the manufacture of a stator 1 was described on the basis of the manufacture of a series composite G1 of a plurality of stators 1 and subsequent release of this series composite by separating the individual stators 1 from one another. However, the present invention is not limited to this type of manufacture. In particular, a single stator 1 can also be manufactured independently of other stators 1 by forming a stator frame 3 by a stacked composite of individual independent components 4, 5.1, 5.2, 4, 6 and providing it with electromechanical actuators 2 and a friction element 9.

Furthermore, the series composites disclosed in the above description are exemplarily each formed by three components arranged next to each other. It goes without saying that the respective series composites can have any number of components as long as the individual series composites remain easy to handle for manufacturing the stators.

The separation process for producing the individual components from the sheetlike semi-finished product can be any two-dimensional separation process. Preferably, it is a laser cutting process, a water jet cutting process or a spark erosion process. The same applies to the separation process used to separate the individual stators 1 from the series composite G1.

List of reference signs

| | |
|---|---|
| 1 | Stator |
| 2 | Electromechanical actuator |
| 3 | Stator frame |
| 4 | Spring sheet |
| 4.1 | Spring sheet half |
| 5 | Stator base |
| 5.1 | Support element |
| 5.2 | Housing element |
| 6 | Flat spring |
| 7 | Cavity |
| 8 | Screw |
| 9 | Friction element |
| G1 | Series composite of stators |
| G3 | Series composite of stator frames |
| G4 | Series composite of spring sheets |
| G4.1 | Series composite of spring sheet halves |
| G5 | Series composite of stator bases |
| G5.1 | Series composite of support elements |
| G5.2 | Series composite of housing elements |
| G6 | Series composite of flat springs |
| S | Welded connection |

1. A method for manufacturing at least one stator for an electromechanical inertial drive, wherein the stator comprises:
at least one electromechanical actuator; and
a stator frame for accommodating the actuator,
wherein the stator frame comprises a plurality of components that are manufactured from at least one sheetlike semi-finished product in a separation process and are arranged in a stacked composite to form the stator frame.

2. The method according to claim 1, wherein the stator frame comprises at least two spring sheets and a stator base, which comprises at least two components and is arranged between the two spring sheets.

3. The method according to claim 2, wherein an additional flat spring is arranged at one of the spring sheets.

4. The method according to claim 1, wherein the components of the stator frame are manufactured from at least two different plate-shaped semi-finished products having different thicknesses.

5. The method according to claim 1, wherein different components of the stator frame are manufactured from a common plate-shaped semi-finished product.

6. The method according to claim 1, wherein the stator base comprises a cavity, in which the at least one electromechanical actuator is inserted, and the components of the stator base are preferably manufactured from semi finished products of the same thickness, particularly preferably from the same semi finished product.

7. The method according to claim 6, wherein the components of the stator base are formed by a support element, on which the at least one electromechanical actuator is placed, and a housing element, which at least partially surrounds the at least one electromechanical actuator.

8. The method according to claim 1, wherein the components of the stator frame are aligned with each other via reference means.

9. The method according to claim 1, wherein the separation method is a laser cutting method, a water jet cutting method or a spark erosion method.

10. The method according to claim 1, wherein several component groups, which are each formed by a series composite of several components of the same type, are arranged in a stacked composite to form a plurality of stator frames in the series composite.

11. The method according to claim 10, wherein the components in a series composite are manufactured integrally connected from a semi-finished product.

12. The method according to claim 10, wherein the plurality of stator frames in the series composite are separated from one another in order to provide individual stator frames.

13. The method according to claim 11, wherein the plurality of stator frames in the series composite are separated from one another in order to provide individual stator frames.

14. The method according to claim 6, wherein the components of the stator base are manufactured from semi-finished products of the same thickness.

15. The method according to claim 14, wherein the components of the stator base are manufactured from the same semi-finished product.

16. The method according to claim 6, wherein the support element is rod-shaped and the housing element is U-shaped.

17. The method according to claim 8, wherein the reference means are formed by through-holes and/or threaded holes.

18. The method according to claim 8, wherein the stacked composite is fixed by connecting means.

19. The method according to claim 18, wherein the connecting means are screws or welded connections.
